(19) United States
(12) Patent Application Publication
(10) Pub. No.: US 2024/0332569 A1
(43) Pub. Date: Oct. 3, 2024

(54) ELECTROCHEMICAL CELL HUMIDITY STABILIZATION SYSTEM

(71) Applicant: Robert Bosch GmbH, Stuttgart (DE)

(72) Inventors: Mordechai KORNBLUTH, Brighton, MA (US); Daniil KITCHAEV, Brookline, MA (US); Karim GADELRAB, Boston, MA (US); Jake CHRISTENSEN, Elk Grove, CA (US)

(21) Appl. No.: 18/191,925

(22) Filed: Mar. 29, 2023

(51) Int. Cl. H01M 8/04119; H01M 8/023; H01M 8/1004

(52) U.S. Cl. CPC H01M 8/04171; H01M 8/023; H01M 8/1004; H01M 2008/1095

(57) ABSTRACT

An electrochemical cell includes a plurality of components including a membrane electrode assembly including gas diffusion layers, catalyst layers, an exchange membrane, and bipolar plates, the cell being preset to have a target operational relative humidity (RH), and a humidity stabilization system located in or adjacent to at least one of the plurality of components, the system including a hygroscopic material having a critical relative humidity (CRH) value equal to or greater than the target operational RH of the cell.

### TECHNICAL FIELD

The present disclosure relates to a water management system for an electrochemical cell, specifically a humidity stabilization system, and a method of making and using the same.

### BACKGROUND

Hydrogen technologies such as fuel cells and electrolyzers are becoming increasingly popular due to their central role in a clean energy economy. The cells that produce hydrogen (electrolysis) and consume it to produce energy (fuel cells) are of particular interest due to their ability to transport energy at relative light weights and ability to be refueled.

### SUMMARY

In at least one embodiment, an electrochemical cell is disclosed. The cell has a plurality of components including a membrane electrode assembly including gas diffusion layers, catalyst layers, an exchange membrane, and bipolar plates, the cell having a target operational relative humidity (RH). The cell further includes a humidity stabilization system located in or adjacent to at least one of the plurality of components. The system includes a hygroscopic material having a critical relative humidity (CRH) value equal to or greater than the target operational RH of the cell. The hygroscopic material may be a compound having an ionic bond. The hygroscopic material may react exothermically with water. The hygroscopic material may undergo a phase change upon contact with water. The hygroscopic material may include one or more of sulfates, phosphates, nitrates, chlorides, or a combination thereof. The hygroscopic material may include potassium sulfate. The humidity stabilization system may be located in a gas diffusion layer. The humidity stabilization system may include a plurality of hygroscopic materials having different CRHs.

In another embodiment, an electrochemical cell is disclosed. The cell includes a membrane electrode assembly including gas diffusion layers, catalyst layers, and an exchange membrane. The cell has a target operational relative humidity (RH). The cell further includes a humidity stabilization system located adjacent to the membrane electrode assembly. The system includes a hygroscopic material having a critical relative humidity (CRH) value equal to or greater than the target operational RH of the cell. The cell may further include a physical barrier retaining the hygroscopic material within the cell. The physical barrier may be water vapor permeable and liquid water impermeable. The physical barrier may form a chamber. The physical barrier may be a porous membrane between a gas diffusion layer and the hygroscopic material. The hygroscopic material may include one or more of sulfates, phosphates, nitrates, chlorides, or a combination thereof. The hygroscopic material may include potassium sulfate.

In yet another embodiment, an electrochemical cell is disclosed. The cell includes a membrane electrode assembly including gas diffusion layers, catalyst layers, and an exchange membrane. The cell has a target operational relative humidity (RH). The cell has a bipolar plate including a humidity stabilization system including a hygroscopic material having a critical relative humidity (CRH) value equal to or greater than the target operational RH of the cell and arranged in a pattern. The pattern may be periodic such that the bipolar plate material alternates with the hygroscopic material. The pattern may be perpendicular to gas flow channels within the bipolar plate. The hygroscopic material may be configured with a switch. The hygroscopic material may include one or more of sulfates, phosphates, nitrates, chlorides, or a combination thereof. The hygroscopic material may include potassium sulfate.

### BRIEF DESCRIPTION OF THE DRAWINGS

FIG. 1 is a schematic depiction of a fuel cell;

FIG. 2 shows a schematic depiction of a fuel cell with relevant chemical reactions;

FIG. 3 shows a schematic depiction of an electrolyzer with relevant chemical reactions;

FIG. 4 shows a schematic depiction of a non-limiting example of an electrochemical cell having a humidity stabilization system with a physical barrier according to one or more embodiments disclosed herein;

FIGS. 5A, 5B are schematic depictions of non-limiting examples of electrochemical cells having a humidity stabilization system as disclosed herein;

FIG. 6 is a schematic depiction of a non-limiting example of a portion of an electrochemical cell with an enlarged, detailed schematic view of a humidity stabilization system disclosed herein; and

FIG. 7 shows a schematic depiction of a non-limiting example of a portion of an electrochemical cell with a bipolar plate including a humidity stabilization system disclosed herein.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the disclosure. Practice within the numerical limits stated is generally preferred. Also, unless expressly stated to the contrary: percent, “parts of,” and ratio values are by weight; the description of a group or class of materials as suitable or preferred for a given purpose in connection with the disclosure implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. Generally, the term “about” denoting a certain value is intended to denote a range within ±5% of the value. As one example, the phrase “about 100” denotes a range of 100±5, i.e. the range from 95 to 105. Generally, when the term “about” is used, it can be expected that similar results or effects according to the disclosure can be obtained within a range of ±5% of the indicated value. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)}O_{(0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

As used herein, the term “and/or” means that either all or only one of the elements of said group may be present. For example, “A and/or B” means “only A, or only B, or both A and B”. In the case of “only A,” the term also covers the possibility that B is absent, i.e. “only A, but not B”.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Electrochemical cells that convert chemical energy of a fuel (e.g. H₂) and an oxidizing agent into electricity through a pair of electrochemical half (redox) reactions, have become an increasingly popular technology. Electrochemical cells are now a promising alternative transportation technology capable of operating without emissions of either toxins or green-house gases.

For example, a proton-exchange membrane fuel cell (PEMFC) represents an environment friendly alternative to internal combustion engines for a variety of vehicles such as cars and buses. A PEMFC typically features a relatively high efficiency and power density. A very attractive feature of the PEMFC engine are no carbon emissions, provided that the hydrogen fuel has been gained in an environmentally friendly manner. Besides being a green engine, the PEMFC may be used in other applications such as stationary and portable power sources.

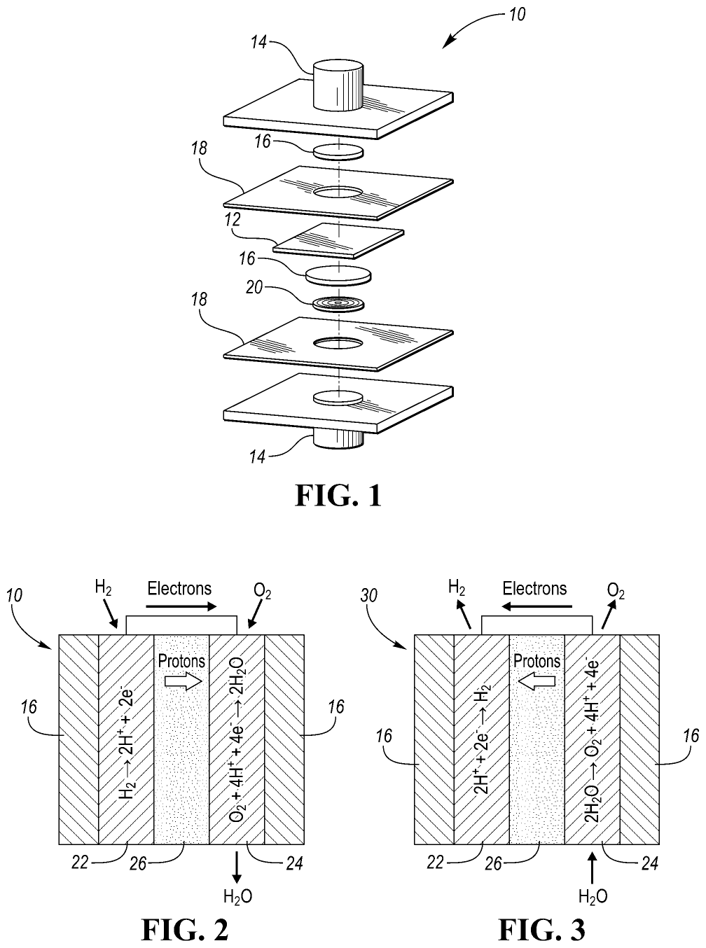

A non-limiting example of a PEMFC is depicted in FIG. 1. A core component of the PEMFC 10 that helps produce the electrochemical reaction needed to separate electrons is the Membrane Electrode Assembly (MEA) 12. The MEA 12 includes subcomponents such as electrodes (cathode, anode), catalysts, and polymer electrolyte membranes. Besides MEA 12, the PEMFC 10 typically includes other components such as current collectors 14, gas diffusion layer(s) 16, gaskets 18, and bipolar plate(s) 20.

A fuel cell reaction schematic is shown in FIG. 2. FIG. 2 depicts reaction at the anode catalyst layer 22, cathode catalyst layer 24, movement of proton through the proton exchange membrane (PEM) 26, movement of electrons through the cell 10 as well as water being a product of the reactions.

In parallel opposite to a PEMFC is a PEM electrolyzer. Whereas the PEMFC consumes hydrogen and oxygen to create electricity and water, a PEM electrolyzer is an electrochemical device designed to convert electricity and water into hydrogen and oxygen. A PEMFC and a PEM electrolyzer may be used together to store energy via hydrogen. The PEM electrolyzer utilizes electrolysis for hydrogen production. The PEM electrolyzer may be utilized in applications including industrial, residential, and military applications and technologies focused on energy storage such as electrical grid stabilization from dynamic electrical sources including wind turbines, solar cells, or localized hydrogen production for industrial and other uses.

A depiction of the electrolysis principle, utilized by a PEM electrolyzer, with relevant reactions is depicted in FIG. 3. The electrolyzer 30 includes the PEM 26, cathode with the cathode catalyst layer 22, and anode with the anode catalyst layer 24. During electrolysis, water is broken down into oxygen and hydrogen in anodic and cathodic electrically driven evolution reactions. The reactant liquid water (H₂O) permeates through the anode porous transportation layer (PTL) to the anode catalyst layer 24, where the oxygen evolution reaction (OER) occurs. The protons (H⁺) travel via the PEM 26, and electrons (e−) conduct through an external circuit during the hydrogen evolution reaction (HER) at the cathode catalyst layer 22.

The electrochemical cell technology; however, presents a number of challenges connected to its maintenance, sustainable performance over time, longevity, and production cost. For example, electrochemical cells have a highly corrosive environment requiring materials capable of withstanding the challenging conditions. Additionally, water management of the cells is a challenge as excess water may create various problems in the cells.

In many electrochemical cells, water is either a product of the cell's operation (fuel cells) or a necessary reagent (electrolyzers). Additionally, the electrolyte that conducts ions includes primarily or partially water or a hydrated membrane. As such, water content is essential for the proper transport of ionic species through the electrolyte. The water-mediated transport may be either acidic (proton transport) or basic (hydroxide transport). A common low-cost and low-volume PEM such as Nafion or an anion exchange membrane (AEM) such as Aemion may be used for the transport. At the same time, water content needs to be balanced with that of other reagents and products such as oxygen and hydrogen gas, which may be transported in and out of the cell at a sufficiently high rate.

Many water-based electrochemical cells are designed to operate at a range of relative humidities (RH). If the RH is too low, the transport of water and ionic species in the electrolyte and around the electrodes may be too low, leading to inferior current density. If the RH is above 100%, water may condense as droplets, leading to “flooding” conditions which prevent oxygen transport to or from the catalyst, similarly limiting the output of the electrochemical cell. The water droplets may be difficult to remove from the cell, often requiring extensive heating or drying of the cell, or extensive modulation of cell pressure due to hysteresis and capillary effects. The flooding is most concerning during start-up and shutdown when the cell is cold and wet, relative to the operating conditions. The term “flooding” relates to an undesirable amount of water filling the component pores and causing blockage of oxygen transport in the catalyst layer, which may result in a reduced cell performance. “Flooding” may relate to both water vapor and liquid water such as droplets.

Traditional strategies implemented to control unwanted presence of water in electrochemical cells include designing flow channels, pore designs, silica addition, addition of wicking fibers, low thermal conductivity materials, pressure drop, flow channel hydrophilicity, water injection, temperature increase, or the like. For example, porous fiber wicks have been added to the fuel cell to control humidification of the cell. Yet, none of the existing strategies offer an adequate solution in all operating conditions, and water management of electrochemical cells remains a challenge.

Therefore, there is a need to develop an electrochemical cell that does not reach 100% humidity in any local region of the cell or any other conditions that would create a condensate blocking gas transport in the cell. Furthermore, it would be desirable to identify a reliable water management system, which would have low cost and high efficiency.

In one or more embodiments, an electrochemical cell is disclosed. The cell may be a fuel cell or an electrolyzer, for example as schematically described above. The cell may include a humidity stabilization system or a humidity buffer. The humidity stabilization system may be a water management system. The system may include one or more components such as a humidity stabilization material, a physical barrier, a selective membrane, one or more switches, or a combination thereof. The system may include a humidity stabilization feedback loop.

The humidity stabilization system may be based on the cell's predetermined or target relative humidity (RH) value(s) or range(s) at which the cell is structured or preset to operate. The target operational RH may be lower than 100%. The target operational RH may be set to optimize proton conductivity, oxygen transport, lifetime, and/or overall cell performance. The target RH may be different for different cells, stacks, or electrochemical systems.

The humidity stabilization system may include a humidity stabilization material. The humidity stabilization material may include a hygroscopic material or a material which attracts water vapor from air and/or liquid water when exposed to a source of water. The material may attract and/or bind the water vapor or liquid water by chemical sorption, physisorption, absorption, adsorption, or any other reaction with liquid water or water vapor.

The hygroscopic material may have a critical relative humidity (CRH) at a temperature. Below CRH, the material has minimal uptake of water. Above CRH, the water is bound by the hygroscopic material to form a solution. The CRH may be defined as the relative humidity of the surrounding atmosphere at a certain temperature at which the material begins to bind moisture from the atmosphere and below which is will not bind atmospheric moisture.

The hygroscopic material may have a CRH equal to or above the desired, predetermined, calculated, or target operating RH of the cell. Ideally, the material may have a CRH near the desired RH of the cell at the desired temperatures. The desired temperatures may be temperatures at the start-up, shutdown, operating temperatures, or a combination thereof.

A non-limiting example material may be a compound having an ionic bond such as a salt having a CRH. Below the CRH, the salt has minimal uptake of water. Above the CRH, the water is absorbed by the salt to form a solution. This is related to the five types of Brunauer sorption isotherms, but unlike the Brunauer formalism, where the water uptake is first adsorbed on the surface and then forms a liquid, a salt undergoes a phase change for dissolution.

The salt may have a CRH above the desired RH of the cell. When the atmospheric humidity is equal to or greater than the CRH of a salt, the salt will take up water until all of the salt is dissolved to yield a saturated solution. For example, CRH of NaCl or table salt (halite) is 75.6%. When the RH is lower than 75.6%, the solution evaporates and the salt crystalizes. When the RH is higher than 75%, the salt absorbs the air moisture, and the salt dissolves.

Non-limiting example salts suitable for the system disclosed herein may include sulfates, phosphates, nitrates, chlorides, the like, or their combination. A non-limiting example may include potassium sulfate (K₂SO₄) which has a CRH of about 96-99% up to about 50° C. If the RH of the cell is higher than the 96-99%, the excess water will be absorbed by the salt, and the water will dissolve the salt. Additional non-limiting examples of the suitable salts may include potassium nitrate (KNO₃), potassium chloride (KCl), ammonium sulfate (NH₄)SO₄, monoammonium phosphate (NH₄)(H₂PO₄), monocalcium phosphate Ca(H₂PO₄)₂, or sodium chloride (NaCl). The hygroscopic material may be prepared as a blend of salts, thus adjusting the CRH of the salt blend. For example, the blend may include one or more salts named herein or in Table 1. Table 1 below provides information on hygroscopic salts in relation to their CRH at various temperatures. As can be observed from Table 1, some salts have a relatively low RH with increasing temperature such as magnesium nitrate while other salts have a relatively uniform CRH irrespective of temperature changes such as ammonium sulfate. Depending on the target RH of the cell, stack, system, a suitable hygroscopic salt may be chosen based on the anticipated temperatures during the high humidity or flooding events, the target RH of the system, or both.

TABLE 1
Saturated salt/water solutions in relation to temperature and relative humidity

| | Temperature [° C.] | | | | | | | | | | |
|---|---|---|---|---|---|---|---|---|---|---|---|
| | 0 | 5 | 10 | 15 | 20 | 25 | 30 | 35 | 40 | 50 | 60 |
| Saturated Salt Solution | Relative Humidity over the Salt Solution [%] | | | | | | | | | | |
| Ammonium nitrate - NH₄NO³ | | | 75 | 70 | 67 | 64 | 60 | 53 | | | |
| Ammonium sulphate - (NH₄)₂SO₄ | 82 | 82 | 82 | 82 | 81 | 81 | 81 | 80 | 80 | 79 | |
| Lithium chloride - LiCl ¹⁾ | | | | | 11.31 | 11.35 | 11.28 | 11.25 | 11.21 | 11.10 | 10.95 |
| Magnesium chloride - MgCl₂ | 34 | 34 | 33 | 33 | 33 | 33 | 32 | 32 | 32 | 31 | 29 |
| Magnesium nitrate - Mg(NO₃)₂ | 60 | 59 | 57 | 56 | 54 | 53 | 51 | 50 | 48 | 45 | |
| Natrium Chloride - NaCl ¹⁾ | 75.51 | 75.65 | 75.67 | 75.61 | 75.47 | 75.29 | 75.09 | 74.87 | | | |
| Potassium sulphate - K₂SO₄ | 99 | 98 | 98 | 98 | 98 | 97 | 97 | 97 | 96 | 96 | |
| Potassium nitrate - KNO₃ | 96 | 96 | 96 | 95 | 95 | 94 | 92 | 91 | 89 | 85 | |
| Potassium chloride - KCl | 89 | 88 | 87 | 86 | 85 | 84 | 84 | 83 | 82 | 81 | 80 |
| Potassium acetate - CH₃CO₂K | | | 23 | 23 | 23 | 23 | 22 | | | | |
| Potassium hydroxide - KOH | | 14 | 12 | 11 | 9 | 8 | 7 | 7 | 6 | 6 | 5 |
| Sodium chloride - NaCl | 76 | 76 | 76 | 76 | 75 | 75 | 75 | 75 | 75 | 74 | 75 |
| Sodium nitrite - NaNO₂ | | | | | 65 | 64 | 63 | 62 | 61 | | |
| Sodium dichromate - Na₂Cr₂O₇ | 61 | 59 | 57 | 57 | 55 | 54 | 53 | 51 | 50 | 49 | 47 |

Presence of the salt with CRH greater than the target RH in the cell results in any excess water interacting with the hygroscopic material instead of flooding the cell during a high-humidity condition even when a deviation from the target RH occurs. The excess water is absorbed, thus providing a humidity buffer preventing immediate condensation.

Because the hygroscopic material may have the unique behavior (phase change) and property CRH, the water uptake may be not a mere absorption or physisorption, but a dissolution reaction. This renders the material capable of holding an increased amount of water, in comparison to materials capable of only absorption and physisorption. The herein-disclosed feedback loop may thus be used to detect and mitigate unwanted flooding conditions and returning the cell to the desired RH near the CRH.

The dissolution reaction of a salt in water entails water molecules pulling the salt ions apart, breaking the ionic bond that hold them together. After the salt ions are pulled apart, the salt atoms are surrounded by water molecules, resulting in a homogenous solution of salt and water. The chemical reaction of the hygroscopic material with the water vapor, liquid water in the cell may be endothermic or exothermic. The exothermic reaction has the advantage of emitting heat into the cell, which in turn may raise the dew point and prevent further condensation of water in the cell. The hygroscopic material having an exothermic reaction with water may thus be a condensation preventer. A non-limiting example salt having an exothermic reaction with water may be calcium chloride.

The system may also include a physical barrier permeable to water vapor, but not to liquid water. The physical barrier may form a chamber, enclosure, pocket, cavity, bordered area, or the like. The physical barrier may ensure that the hygroscopic material is contained after dissolution by the excess water the material absorbed. Without the barrier, once the hygroscopic material dissolves, the solution could exit the cell. The presence of the physical barrier enables retention of the hygroscopic material within the cell. Once the cell dries out, in other words, once the RH of the cell drops below the threshold level such that the excess moisture evaporates, the hygroscopic material solidifies and is ready for the next high humidity event.

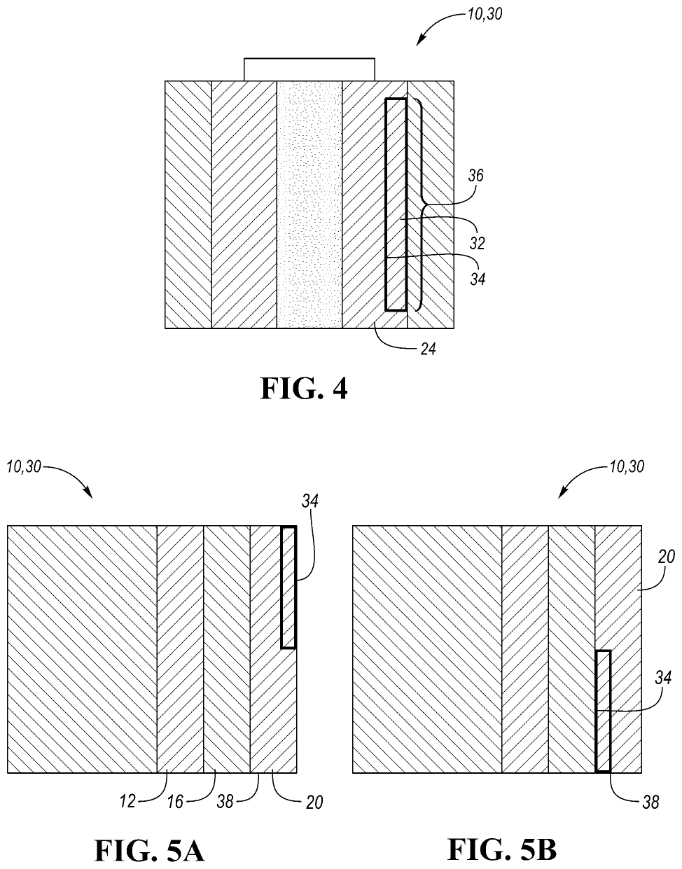

A non-limiting example of a physical barrier 32 is shown in FIG. 4. In the non-limiting example, the physical barrier is located in the cathode catalyst layer 24 of the cell 10, 30, and the hygroscopic material 34 is located in the area 36 defined by the physical barrier 32. The non-limiting example is for illustration purposes only. The physical barrier may have any size, shape, or configuration, different from the one shown in FIG. 4.

Alternatively, the hygroscopic material may be not enclosed within a physical barrier and may be sacrificed in the cell outstream after phase change to a solution. In such case, the hygroscopic material may be recharged or replaced during a routine maintenance of the cell.

A plurality of hygroscopic materials may be used in the same cell or stack of cells. The materials may differ in their chemical composition, physical properties, CRH at one or more different temperatures, or a combination thereof. The materials may be individually exposed to the water vapor in the cell environment, depending on the various operating conditions of the cell such as temperature, pressure, and/or the like. For example, at first temperature, a first hygroscopic material may be exposed to water vapor while at second temperature different than the first temperature, a second material may be exposed to water vapor in the same cell. The first temperature may be lower or higher than the second temperature. The first and second materials may be the same or different materials regarding their chemical and/or physical properties.

The humidity stabilization material may be included in the vicinity, close vicinity, adjacent to, immediately adjacent to one or more components of the cell. For example, the component may be a GDL, catalyst layer, or BPP. The hygroscopic material may be included in the catalyst layer such as the cathode catalyst layer, anode catalyst layer, or both. The hygroscopic material may be included in the GDL, porous transport layer, cell instream or inlet, cell outstream or outlet, or a combination thereof. The material may be included in certain sections of one or more components of the cell.

The hygroscopic material may be included as a surface layer or a coating. The layer or coating may be continuous or discontinuous. The layer may have uniform or non-uniform thickness. The thickness of the layer may be gradually increasing or decreasing towards a component, cell inlet or outlet. The hygroscopic material may form islands on the body of a cell component such as the BPP. Islands relate to discreet formations of the material surrounded by another material such as the component body material. The hygroscopic material may be included as a fiber, on a surface or a fiber, or adjacent to a fiber. The hygroscopic material may form a pattern on a component surface. The pattern may be regular or irregular. A greater amount of the material may be deposited in an area where water accumulation may be anticipated, for example in the vicinity of the inlet, outlet, pores of the catalyst layer, etc.

The hygroscopic material may form one or more humidity stabilization layers. The layers may be applied onto various surfaces of a cell. For example, a BPP may be combined with the humidity stabilization layer in different geometric regions. A non-limiting example of the BPP and humidity stabilization layer may be located immediately adjacent to, adjacent to, alongside, or adjoining an inlet or outlet. Alternatively, the BPP and humidity stabilization layer may be located opposite or at a distance from an inlet or outlet.

FIG. 5A shows a non-limiting example of a cell 10, 30 having a BPP 20 with the hygroscopic material layer 34 located on the opposite side of the BPP than the inlet/outlet 38. FIG. 5B shows a cell 10, 30 having a BPP 20 with the hygroscopic material layer 34 located adjacent the inlet/outlet 38. The layer in either embodiment may extend the entire length or a partial length of the component such as the BPP, or be provided in a pattern such as is shown in FIG. 7.

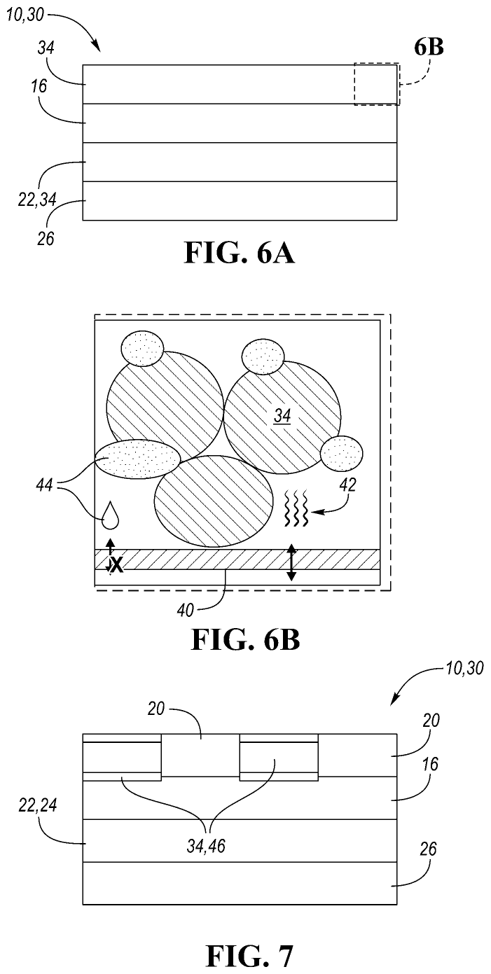

The humidity stabilization material may be included in the vicinity, close vicinity, adjacent to, immediately adjacent to a GDL to prevent condensation in the GDL. FIG. 6 illustrates a non-limiting example of such an embodiment. In FIG. 6, the hygroscopic material later 34 is immediately adjacent the GDL 16, adjacent the catalyst layer 22, 24, adjacent the membrane 26. As can be seen in FIG. 6, the hygroscopic material layer 34 includes a porous membrane 40. The porous membrane 40 may be a selective membrane allowing water vapor 42 movement to and from the humidity stabilization region of the cell, the layer 34, but preventing movement of water droplets 44 or liquid water from the layer 34. The selective membrane may thus serve as a type of the physical barrier discussed above.

The system disclosed herein may further include one or more mechanisms structured to activate and/or deactivate based on the RH value of the cell. The one or more mechanisms may include one or more switches. The switches may be electrical, mechanical, or both. The switches may be structured as an electrical or mechanical barrier, preventing outflow of the hygroscopic material from the cell such as when the hygroscopic material is dissolved.

The switches may be provided onto the BPP, for example, prior to a cell stack assembly. The switches may be printed or embossed onto the BPP material. The switches may be included in a periodic pattern to enable a conductive path through the BPP. The periodic pattern may be parallel or perpendicular to the gas flow channels of the cell. The switches may contain the same or different hygroscopic material. A non-limiting example of a cell having two switches is shown in FIG. 7. FIG. 7 shows a portion of a cell 10, 30 having a membrane 26 adjacent the catalyst layer 22, 24, adjacent the GDL 16. The GDL 16 is adjacent a BPP 20 including a pattern of BPP material including the hygroscopic material 34 that is covered or uncovered by a switch 46. The switch may be opened and closed manually, by a processing unit, by a feedback loop, or in some other way.

The hygroscopic material may be coated with hydrophilic material(s) or domain(s) to further enhance condensation in the regions of the cell including the hygroscopic material. The enhanced hydrophilicity may further increase movement of water vapor, water droplets, or both towards the hygroscopic material and away from pores of the cell. Additionally, a hydrophobic coating may be provided on one or more portions of the cell, further deterring water from entering the regions.

The system described herein may be included in an electrochemical cell, electrolyzer, as described herein, but also in a test station or a diagnostic device to avoid condensation during testing, prototyping, maintenance, diagnostics, the like, or a combination thereof.

A method of providing a humidity stabilization system in an electrochemical cell or a similar device is disclosed. The method may include identifying a target RH of the cell during operation, start up, shut down, or a combination thereof. The method may include identifying a hygroscopic material such as a salt having a CRH equal to or above the RH of the cell. The method may include providing the hygroscopic material into the cell. The providing may include applying the hygroscopic material onto one or more components of the cell such as the catalyst layer, GDL, BPP, or a combination thereof. The applying may include adding a hygroscopic material as a layer, discreet material, or otherwise within the cell. The applying may be on a surface or body of a component. The providing may include applying the hygroscopic material together with a switch, or as part of a switch. The method may further include providing a physical barrier, porous membrane, or both to a cell component to define a boundary within which the hygroscopic material should be and remain located in.

The method may further include regulating, controlling, or maintaining RH of a cell at a desired, predetermined, target, calculated value or in a desirable, predetermined, calculated target range via inclusion of the hygroscopic material within the cell as was described herein.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. An electrochemical cell comprising:
a plurality of components including a membrane electrode assembly including gas diffusion layers, catalyst layers, an exchange membrane, and bipolar plates, the cell having a target operational relative humidity (RH); and
a humidity stabilization system located in or adjacent to at least one of the plurality of components, the system including a hygroscopic material having a critical relative humidity (CRH) value equal to or greater than the target operational RH of the cell.

2. The cell of claim 1, wherein the hygroscopic material is a compound having an ionic bond.

3. The cell of claim 1, wherein the hygroscopic material reacting exothermically with water.

4. The cell of claim 1, wherein the hygroscopic material undergoes a phase change upon contact with water.

5. The cell of claim 1, wherein the hygroscopic material includes one or more of sulfates, phosphates, nitrates, chlorides, or a combination thereof.

6. The cell of claim 1, wherein the hygroscopic material comprises potassium sulfate.

7. The cell of claim 1, wherein the humidity stabilization system is located in a gas diffusion layer.

8. The cell of claim 1, wherein the humidity stabilization system includes a plurality of hygroscopic materials having different CRHs.

9. An electrochemical cell comprising:
a membrane electrode assembly including gas diffusion layers, catalyst layers, and an exchange membrane; the cell having a target operational relative humidity (RH); and
a humidity stabilization system located adjacent to the membrane electrode assembly, the system including
a hygroscopic material having a critical relative humidity (CRH) value equal to or greater than the target operational RH of the cell; and
a physical barrier retaining the hygroscopic material within the cell.

10. The cell of claim 9, wherein the physical barrier is water vapor permeable and liquid water impermeable.

11. The cell of claim 9, wherein the physical barrier forms a chamber.

12. The cell of claim 9, wherein the physical barrier is a porous membrane between a gas diffusion layer and the hygroscopic material.

13. The cell of claim 9, wherein the hygroscopic material includes one or more of sulfates, phosphates, nitrates, chlorides, or a combination thereof.

14. The cell of claim 9, wherein the hygroscopic material comprises potassium sulfate.

15. An electrochemical cell comprising:
a membrane electrode assembly including gas diffusion layers, catalyst layers, and an exchange membrane, the cell having a target operational relative humidity (RH); and
a bipolar plate including a humidity stabilization system including a hygroscopic material having a critical relative humidity (CRH) value equal to or greater than the target operational RH of the cell and arranged in a pattern.

16. The cell of claim 15, wherein the pattern is periodic such that the bipolar plate material alternates with the hygroscopic material.

17. The cell of claim 16, wherein the pattern is perpendicular to gas flow channels within the bipolar plate.

18. The cell of claim 15, wherein the hygroscopic material is configured with a switch.

19. The cell of claim 15, wherein the hygroscopic material includes one or more of sulfates, phosphates, nitrates, chlorides, or a combination thereof.

20. The cell of claim 15, wherein the hygroscopic material comprises potassium sulfate.
